(19) United States
(12) Patent Application Publication
(10) Pub. No.: US 2024/0410069 A1
(43) Pub. Date: Dec. 12, 2024

(54) METHOD FOR MANUFACTURING IRON METAL BY ELECTROLYSIS

(71) Applicant: ArcelorMittal, Luxembourg (LU)

(72) Inventor: Hervé LAVELAINE DE MAUBEUGE, Metz (FR)

(21) Appl. No.: 18/717,023

(22) PCT Filed: Dec. 20, 2021
(86) PCT No.: PCT/IB2021/062004

§ 371 Date: Jun. 6, 2024

(51) Int. Cl. C25C 1/06; C25C 7/06

(52) U.S. Cl. CPC C25C 1/06; C25C 7/06

(57) ABSTRACT

A method for manufacturing iron metal in an apparatus through reduction of iron ore by an electrolysis reaction, the electrolysis reaction generating a gas, the apparatus including at least one casing including a gas permeable anode plate, a cathode plate, both facing each other and being separated by an electrolyte chamber, the cathode and the anode being connected to an electric power supply, the casing being provided with a circulator for circulating an electrolyte within the chamber and with a inlet to supply iron ore to the chamber, the pressure P of the electrolyte within the casing being maintained at a value of at least Plimit and the voltage V applied between the cathode and said anode being maintained at a value of at least Vlimit, the voltage V being always kept at a value strictly below the reduction curve of the electrolyte for the pressure P.

The invention is related to a method for manufacturing iron metal from iron oxides by an electrolysis process.

### BACKGROUND

Steel can be currently produced at an industrial scale through two main manufacturing routes. Nowadays, the most commonly used production route consists in producing pig iron in a blast furnace, by use of a reducing agent, mainly coke, to reduce iron oxides. In this method, approx. 450 to 600 kg of coke is consumed per metric ton of pig iron; this method, both in the production of coke from coal in a coking plant and in the production of the pig iron, releases significant quantities of CO₂.

The second main route involves so-called “direct reduction methods”. Among them are methods according to the brands MIDREX, FINMET, ENERGIRON/HYL, COREX, FINEX etc., in which sponge iron is produced in the form of HDRI (Hot Direct Reduced Iron), CDRI (cold direct reduced iron), or HBI (hot briquetted iron) from the direct reduction of iron oxide carriers. Sponge iron in the form of HDRI, CDRI, and HBI usually undergo further processing in electric arc furnaces. Even if this second route emits less CO₂ than the previous one it still releases some and relies moreover on carbon fossil fuels.

### SUMMARY OF THE INVENTION

Current developments thus focus on methods allowing to produce iron which release less or even no CO₂ and which is carbon-neutral.

A known alternative method to produce steel from iron ores made of iron oxides is based on electrochemical techniques. In such techniques, iron is produced from iron oxide using an electrolyser unit comprising two electrodes—an anode and a cathode—connected to a source of electric current, an electrolyte circuit and an iron oxide entry into the electrolyser unit. The anode and cathode are constantly immersed in the circulating electrolyte in order to ensure good electrical conduction between said electrodes. The electrolytic reactions produce pure iron plates at the cathode, oxygen at the anode as well as unwnated hydrogen at the cathode. Together with the reduction of the iron ore, it has indeed been observed that a reduction of the electrolyte takes also place, which is generating hydrogen. Iron plates thus obtained may then be melted with other elements such as a carbon source and scrap in electric furnaces to produce steel.

Such process is environmentally friendly as it is not producing any CO₂ to obtain purified iron of good quality. It is however relying on electric power supply and further progresses of productivity are needed.

An aim of the present invention is to remedy the drawbacks of the prior art by providing a method for manufacturing iron ore through electrolysis with an improved productivity.

For this purpose, the invention provides a method for manufacturing iron metal in an apparatus through reduction of iron ore by an electrolysis reaction, said electrolysis reaction generating a gas, the apparatus comprising at least one casing including a gas permeable anode plate, a cathode plate, both facing each other and being separated by an electrolyte chamber, said cathode and said anode being connected to an electric power supply, said casing being provided with means for circulating an electrolyte within the chamber and with means to supply iron ore to said chamber, the pressure P of the electrolyte within said casing being maintained at a value of at least Pₗᵢₘᵢₜ and the voltage V applied between said cathode and said anode being maintained at a value of at least Vₗᵢₘᵢₜ, such Pₗᵢₘᵢₜ and Vₗᵢₘᵢₜ values being previously determined as the voltage and pressure values at the intersection of the respective reduction curves showing the voltage at which the electrolysis of said electrolyte and of said iron ore occurs as a function of the pressure, said voltage V being always kept at a value strictly below said reduction curve of the electrolyte for said pressure P.

The method may also include the following optional characteristics considered individually or according to all possible combination of techniques:
both electrolyte and gases generated during the electrolysis reaction and flowing through the anode plate are recovered and recirculated towards the electrolyte chamber, said recirculated electrolyte being continuously degassed before re-entering said electrolyte chamber and the gasses resulting from the continuous degassing step being evacuated from the casing;
the casing of the apparatus further includes a degassing unit comprising an electrolyte recirculation part extending continuously from anode plate end up to a gas outlet and being in fluidic connection with the electrolyte chamber, said recirculation part comprising a gas-liquid partition means in contact with the anode plate and extending along the recirculation part;
the electrolyte is based on water;
the casing is maintained at a temperature of 100 to 120° C.;
the pressure Pₗᵢₘᵢₜ is at least 24 bars;
the pressure Pₗᵢₘᵢₜ is at least 40 bars;
the electric power supply is fed with renewable energy.

### BRIEF DESCRIPTION OF THE DRAWINGS

Other characteristics and advantages of the invention will be apparent in the below description, by way of indication and in no way limiting, and referring to the appended figures among which:

FIG. 1, which represents a longitudinal section view of an apparatus that can be used in the frame of the invention,

FIG. 2, shows two reduction curves respectively representing the reduction of the electrolyte and of the iron ore as a function of pressure and of applied voltage.

### DETAILED DESCRIPTION

Elements in the figures are illustration and may not have been drawn to scale.

The invention refers to method for the manufacturing of iron metal (Fe) through the reduction of iron ore, containing notably hematite (Fe₂O₃) and other iron oxides or hydroxides, by an electrolysis reaction. Said chemical reaction is well known and described in the case of hematite by the following equation (1):

$${Fe}_{2} {O}_{3} ↔ 2 Fe + \frac{3}{2} {O}_{2} \qquad ( 1 )$$

In the same conditions, the reduction of water, as an example of electrolyte, can be described by the following equation (2):

$${H}_{2} O ↔ {H}_{2} + \frac{1}{2} {O}_{2} \qquad ( 2 )$$

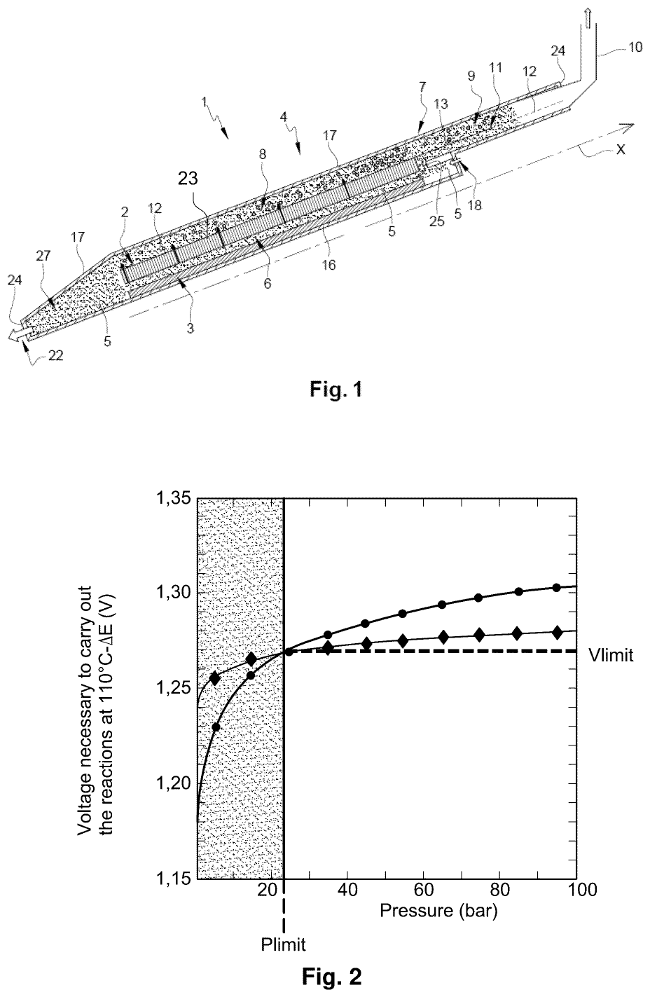

With reference to FIG. 1, an example of an apparatus 1 that can be used to implement the method according to the invention is shown. Such apparatus 1 comprises a casing 4 extending along a longitudinal axis X in which the electrolysis reaction occurs. Said casing 4 is delimited by a base plate 16, a cover plate 17 and two lateral plates 24. In addition, the casing includes a gas permeable anode plate 2 intended to be totally immersed in an electrolyte 5 and a cathode plate 3, both plates facing each other, and being kept at the required distance with fastening means (not depicted). The casing 4 also includes an electrolyte chamber 6 extending longitudinally between the anode plate 2 and the cathode plate 3 up to an evacuation chamber 27. The apparatus 1 finally comprises an electrical power source (not depicted) connected to the anode plate 2 and the cathode plate 3.

In order to produce iron metal through the electrolysis reaction, the electrolyte 5—preferably a sodium hydroxide aqueous solution—flows through the casing 4 inside the electrolyte chamber 6 while the apparatus 1 is operating. The apparatus 1 thus includes means for circulating the electrolyte which comprise an electrolyte circuit (not depicted) connected to an inlet 18 and an outlet 22 managed in the casing 4 and both fluidically connected to the electrolyte chamber 6. Iron ore is preferentially supplied into the apparatus 1 as a powder suspension within the electrolyte 5 through the inlet 18.

As shown on FIG. 2, the reductions curves, showing the voltage at which the electrolysis of the electrolyte (curve with dots) and of the iron ore (curve with rombs) occurs as a function of the pressure, intersect at a point which pressure and voltage are defined as being respectively Pₗᵢₘᵢₜ and Vₗᵢₘᵢₜ. When operating on the left-hand side zone of the graph, at a pressure below Pₗᵢₘᵢₜ, the reduction of the electrolyte will occur preferentially to the reduction of the iron ore.

On the contrary, when operating at a pressure P above Pₗᵢₘᵢₜ, on the right-hand side of the graph, there is an area where it is possible to reduce only iron ore, avoiding the electrolyte reduction. Such area is located below the reduction curve of the electrolyte and above Vₗᵢₘᵢₜ. By selecting a pressure P and a voltage V within this area, the productivity of the electrolysis reaction will be enhanced by avoiding any electrolysis of the electrolyte, while ensuring that the electrolysis of the iron ore will take place.

By operating in that area, the Faradaic efficiency, as is named the selectivity of an electrochemical reaction, can be as high as possible. It is therefore not necessary to replenish the electrolyte that would otherwise be reduced, and the overall electric power consumption is lowered to what is necessary for the iron ore reduction only.

As previously described, during the electrolysis reaction, oxidized iron is reduced to iron metal according to reaction (1) and reduced iron is deposited on the cathode plate 3 while gaseous oxygen is generated. Such oxygen is an electrical insulator that interpose an electrical resistance to the electrical current flow between the electrodes and can thus slow down the iron ore electrolysis reaction. It should therefore preferably be continuously evacuated outside of the casing 4.

For this purpose, the casing 4 can include a degassing unit 7 comprising a gas recovery part 8 extending longitudinally along the opposite side 23 of the anode plate 2 to the electrolyte chamber 6. This gas recovery part 8 is a compartment provided to be filled with the electrolyte 5 and disposed between the anode plate 2 and the cover plate 17. Said gas recovery part 8 is thus provided to recover oxygen escaping through the anode plate 2.

Such degassing unit 7 can also comprise an electrolyte recirculation part 9 extending in continuity with the gas recovery part 8 up to a gas outlet 10 managed in the casing 4. The electrolyte recirculation part 9 is provided to be at least partly filled with the electrolyte 5. In addition, said recirculation part 9 is in fluidic connection with the electrolyte chamber 6. When the apparatus 1 is operating, the recirculation part 9 allows the electrolyte 5 flowing from the gas recovery part 8 to be redirected towards the electrolyte chamber 6 via for example an elbow duct 25 of the electrolyte recirculation part 9 which is adjacent to the anode plate 2 and fluidically connected to the electrolyte chamber 6.

The recirculation part 9 may further comprise a gas-liquid partition means 11 in contact with the anode plate 2 and extending longitudinally from the opposite side 23 of the anode plate 2 along the recirculation part 9. This gas-liquid partition means 11 extends in a plane parallel to the longitudinal axis X an may comprise a solid 13 and a perforated portion 12.

The working of the apparatus 1 of FIG. 1 during the electrolysis reaction will now be described.

The electrolyte 5 is continuously circulating inside a circuit, through the electrolyte chamber 6 from the inlet 18 to the outlet 22, for example thanks to an operating pump (not represented). The electrical power source connected both to the anode plate 2 and to the cathode plate 3 is turned on and the electrolyte chamber 6 is regularly fed with iron ore coming from the means 21 to supply iron ore to the apparatus 1. The casing 4 is almost filled with electrolyte 5, as depicted in FIG. 1, and only the gas outlet 10 and a part of the gas-liquid partition means 11 are free of electrolyte. In these conditions the electrolysis reaction may occur.

In a preferred embodiment the electrical power source is fed with renewable energy which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO₂ to be produced. This further limit the CO₂ footprint of the iron production process.

To monitor the pressure P of the electrolyte inside the casing, it can be equipped with a pressure gauge. In a preferred embodiment, the pressure is controlled by adjusting the exit pressure of oxygen at the gas outlet 10 according to the prescribed value. The voltage V can be adapted to ensure that it remains in the area where only the iron ore reduction takes place.

Iron ore is reduced, and pure iron is deposited on the cathode surface 3, while generated oxygen flow, together with the electrolyte, through the anode plate 2 towards the gas recovery part 8 of the degassing unit 7.

To allow gases circulation from the gas recovery part 8 towards the electrolyte recirculation part 9 and finally to the gas outlet 10, the longitudinal axis X is preferentially inclined relative to a horizontal direction following an angle comprised between 40° and 60°, preferentially 50°. The gas outlet 10 is thus in the highest position of the casing 4 to allow gases evacuation.

While circulating through the gas recovery part 8, the moving gases drive electrolyte 5 from said recovery part 8 to the recirculation part 9. The electrolyte 5 is then driven in the recirculation part 9 by the gases along the gas-liquid partition means 11. Once the electrolyte 5 has flown beyond such means, said electrolyte 5 flows while the gases are retained above the gas-liquid partition means 11.

The gases are continuously flowing along the gas-liquid partition means 11 toward the gas outlet 10, while the electrolyte 5 having circulated through the perforated portion 12 is driven by gravity to the electrolyte chamber 6 and us recirculated. The electrolyte 5 is thus continuously degassed. It is then possible to recirculate the electrolyte 5 within the electrolyte chamber 6 without inducing gas accumulation at the cathode level. This prevents the need to regularly inject a fresh electrolyte flow within the apparatus 1.

What is claimed is:

1-8. (canceled)

9: A method for manufacturing iron metal in an apparatus through reduction of iron ore by an electrolysis reaction, the electrolysis reaction generating a gas, the apparatus comprising at least one casing including a gas permeable anode plate, a cathode plate, both facing each other and being separated by an electrolyte chamber, the cathode plate and the anode plate being connected to an electric power supply, the casing permitting circulation of an electrolyte within the chamber and with a supply inlet to supply iron ore to the chamber, the method comprising:
maintaining a pressure P of the electrolyte within the casing at a value of at least Pₗᵢₘᵢₜ and maintaining a voltage V applied between the cathode plate and the anode plate at a value of at least Vₗᵢₘᵢₜ, such Pₗᵢₘᵢₜ and Vₗᵢₘᵢₜ values being previously determined as the voltage and pressure values at an intersection of respective reduction curves showing the voltage at which the electrolysis of the electrolyte and of the iron ore occurs as a function of the pressure, the voltage V being always kept at a value strictly below the reduction curve of the electrolyte for the pressure P.

10: The method as recited in claim 9 wherein both electrolyte and gases generated during the electrolysis reaction and flowing through the anode plate are recovered and recirculated towards the electrolyte chamber, the recirculated electrolyte being continuously degassed before re-entering the electrolyte chamber and the gases resulting from the continuous degassing step being evacuated from the casing.

11: The method as recited in claim 10 wherein the casing of the apparatus further includes a degassing unit including an electrolyte recirculation part extending continuously from anode plate end up to a gas outlet and being in fluidic connection with the electrolyte chamber, the recirculation part including a gas-liquid partition in contact with the anode plate and extending along the recirculation part.

12: The method as recited in claim 9 wherein the electrolyte is based on water.

13: The method as recited in claim 12 wherein the casing is maintained at a temperature of 100 to 120° C.

14: The method as recited in claim 13 wherein the pressure Pₗᵢₘᵢₜ is at least 24 bars.

15: The method as recited in claim 13 wherein the pressure Pₗᵢₘᵢₜ is at least 40 bars.

16: The method as recited in claim 9 wherein the electric power supply is fed with renewable energy.
